(19) United States
(12) Patent Application Publication
(10) Pub. No.: US 2017/0335975 A1
(43) Pub. Date: Nov. 23, 2017

(54) CUSHION SYSTEM AND VALVE THEREOF

(71) Applicant: APEX MEDICAL CORP., New Taipei City (TW)

(72) Inventor: Wen-bin SHEN, New Taipei City (TW)

(21) Appl. No.: 15/496,783

(22) Filed: Apr. 25, 2017

(30) Foreign Application Priority Data
May 17, 2016 (TW) 105207114

(51) Int. Cl. F16K 1/46; F16K 1/52

(52) U.S. Cl. CPC F16K 1/465; F16K 1/52

(57) ABSTRACT

A valve comprises a base, a cover and a sealing member. The base comprises a passage structure and a retaining member; the cover comprises a corresponding retaining member and at least one hole, and the cover is movably combined with the base and switchable between a first state and a second state relative to the base; a sealing member is disposed between the passage structure and the cover. In the first state, the cover closes the passage structure by the sealing member to prevent the flow of the fluid between the cover and the base; in the second state, at least one fluid channel is formed between the cover and the passage structure and is in communication with the at least one hole, and the retaining member and the corresponding retaining member prevent the cover from being separated from the base when the cover moves relative to the base.

### CROSS-REFERENCE TO RELATED APPLICATION

This application claims priority of Taiwan Patent Application No. 105207114, filed on May 17, 2016, the entirety of which is incorporated by reference herein.

### BACKGROUND OF THE INVENTION

### 1. Field of the Invention

The present disclosure relates to a valve and more particularly to a fluid valve for easy operation. This disclosure further relates to a cushion system using the valve.

### 2. Description of Related Art

Generally, an object to be used after inflated comprises a gas port for inflation or deflation. In a normal state, a closing device such as a plug or a sealing cover for retaining gas in the object is disposed at the gas port, so as to seal the inflated object and prevent gas leakage.

However, it is necessary to release a part of the gas from the object when a user is uncomfortable with excessive gas in the object, such as an air mattress or a cushion. When the user removes the plug or sealing cover from the object, he or she can only determine the proper timing of closing the gas port intuitively because it is difficult to control precisely the rate and amount of gas release from the object. If too much gas is released or discharged, the user needs to inflate the object again and repeats the aforesaid operations. Further, since some plugs or sealing covers are not integrated with the object, the user will be in trouble if he or she unintentionally loses the plugs or sealing covers during removal.

Accordingly, there is a need for allowing the user to control the rate and amount of gas release from the aforesaid object effectively when needed so as to increase operability and ease of use.

### SUMMARY OF THE INVENTION

A primary object of this disclosure is to provide a valve with operability and ease of use.

To achieve the aforesaid and other objects, the valve of this disclosure comprises a base, a cover and a sealing member. The base comprises a passage structure and a retaining member; the cover comprises a corresponding retaining member and at least one hole, and the cover is movably combined with the base and switchable between a first state and a second state relative to the base; the sealing member is disposed between the passage structure of the base and the cover. In the first state, the cover closes the passage structure with the sealing member to prevent the flow of fluid between the cover and the base; in the second state, at least one fluid channel is formed between the cover and the base, the fluid may enter or leave the valve from at least one hole, and the retaining member and the corresponding retaining member may prevent the cover from being separated from the base when the cover is moved relative to the base.

This disclosure further comprises a cushion system using the aforesaid valve. The cushion system comprises a cushion member, a base, a cover and a sealing member. The cushion member comprises a foam material and a covering member covering the foam material; the base is combined with the covering member, and the base comprises a passage structure allowing the flow of a fluid therethrough; the cover comprises at least one hole, and the cover is movably combined with the base and switchable between a first state and a second state relative to the base; the sealing member is disposed between the passage structure of the base and the cover. In the first state, the cover closes the passage structure by the sealing member to prevent the flow of the fluid through the cushion member; in the second state, at least one fluid channel is formed between the cover and the base so as to allow the flow of the fluid to pass through the cushion member via the least one hole. The fluid is directed into the cushion member through the at least one hole by the foam material recovering from a deformed state to an original shape when an external pressure is removed from the cushion member.

Accordingly, with the aforesaid configuration of the valve, the cover will not be separated from the base no matter how the user operates the cover, and the fluid flowing in or out of the valve may be controlled effectively so as to improve the operability and ease of use. The cushion system using the valve is capable of providing an effect of automatic fluid introduction thereinto.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the descriptions, serve to explain the principles of the invention.

FIG. 1 illustrates an exploded view of the first embodiment of a valve of this disclosure;

FIG. 2 illustrates a partial cross-sectional view of the first embodiment of a valve of this disclosure in the first state;

FIG. 3 illustrates a partial cross-sectional view of the first embodiment of a valve of this disclosure in the second state;

FIG. 4 illustrates an exploded view of the second embodiment of a valve of this disclosure;

FIG. 5 illustrates a partial cross-sectional view of the second embodiment of a valve of this disclosure in the first state;

FIG. 6 illustrates a partial cross-sectional view of the second embodiment of a valve of this disclosure in the second state; and

FIG. 7 illustrates a perspective view of the first embodiment of a cushion system of this disclosure.

### DESCRIPTION OF THE EMBODIMENTS

Since various aspects and embodiments are merely exemplary and not limiting, after reading this specification, skilled artisans appreciate that other aspects and embodiments are possible without departing from the scope of the disclosure. Other features and benefits of any one or more of the embodiments will be apparent from the following detailed description and the claims.

The use of “a” or “an” is employed to describe elements and components described herein. This is done merely for convenience and to give a general sense of the scope of the disclosure. Accordingly, this description should be read to include one or at least one and the singular also includes the plural unless it is obvious that it is meant otherwise.

As used herein, the terms “first,” “second,” and the like are used for distinguishing between or referring identical or similar elements or structures and not necessarily for describing a sequential or chronological order thereof. It should be understood that the terms so used are interchangeable under appropriate circumstances or configurations.

Furthermore, as used herein, the terms “comprises,” “comprising,” “includes,” “including,” “has,” “having” or any other variation thereof are intended to cover a non-exclusive inclusion. For example, a component, structure, article, or apparatus that comprises a list of elements is not necessarily limited to only those elements but may include other elements not expressly listed or inherent to such component, structure, article, or apparatus.

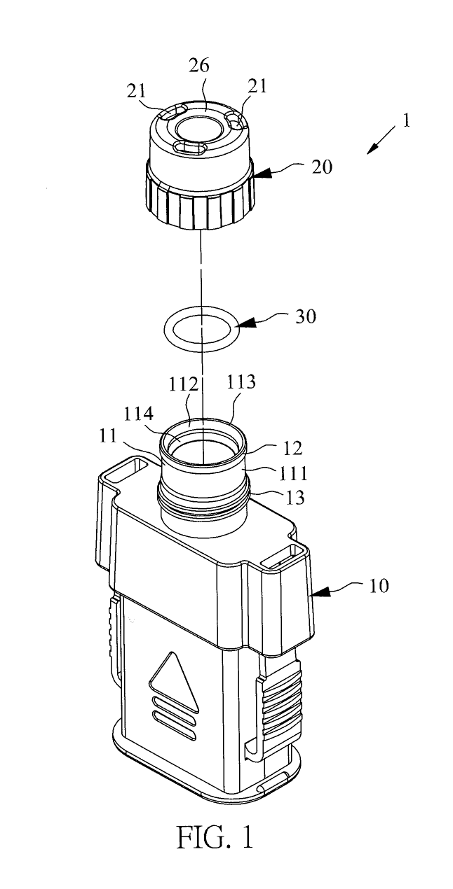

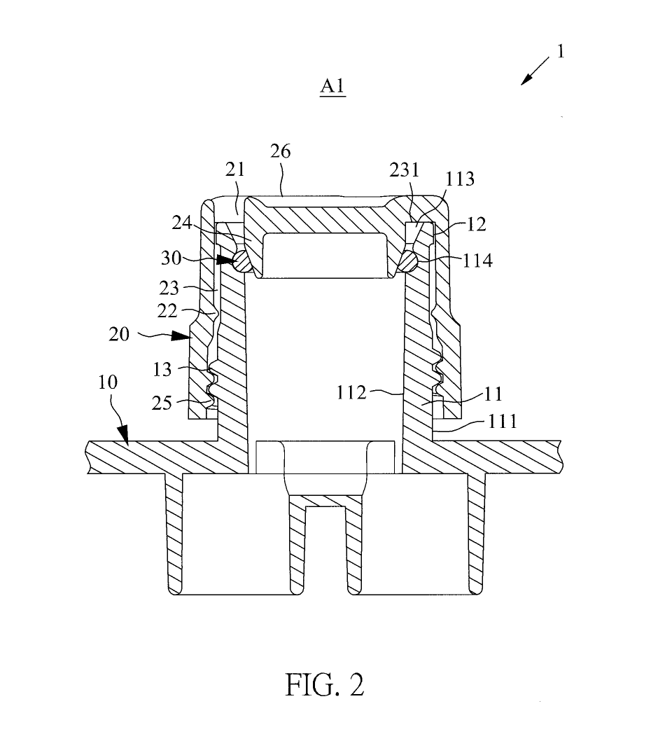

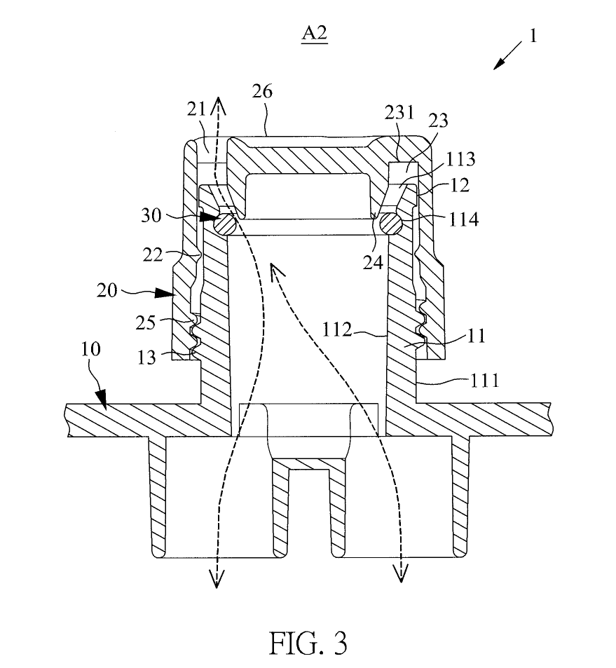

Refer to FIGS. 1 to 3, wherein FIG. 1 illustrates an exploded view of the first embodiment of a valve 1 of this disclosure, FIG. 2 illustrates a partial cross-sectional view of the first embodiment of a valve 1 of this disclosure in the first state, and FIG. 3 illustrates a partial cross-sectional view of the first embodiment of a valve 1 of this disclosure in the second state. As illustrated in FIGS. 1 to 3, the valve 1 comprises a base 10, a cover 20 and a sealing member 30, and the cover 20 is movably combined with the base 10.

The base 10 comprises a passage structure 11 and a retaining member 12. The passage structure 11 forms a pipe-like structure and comprises an outer side 111, an inner side 112 and an opening edge 113. The retaining member 12 is protrudingly disposed on the outer side 111 of the passage structure 11, and the retaining member 12 is configured as an annular protrusion structure. In this embodiment, the base 10 further comprises a first thread part 13. The first thread part 13 is disposed on the outer side 111 of the passage structure 11, and the retaining member 12 is arranged between the opening edge 113 and the first thread part 13. In addition, the passage structure 11 further comprises a groove 114 disposed on the inner side 112 of the passage structure 11. In this embodiment, the groove 114 is configured as an annular groove for receiving the sealing member 30.

The cover 20 comprises at least one hole 21, a corresponding retaining member 22, a receiving portion 23 and a protrusion 24, and the corresponding retaining member 22 and the protrusion 24 are disposed in the receiving portion 23. The corresponding retaining member 22 in this embodiment is configured as an annular protrusion structure, and the receiving portion 23 forms a space of the cover 20. Each hole 21 is communicated with the receiving portion 23 from an outer surface 26 of the cover 20. In this embodiment, each hole 21 is extended to the receiving portion 23 from an upper surface of the cover 20, but this disclosure is not limited thereto; for example, each hole 21 may be in communication with the receiving portion 23 from a lateral surface or other position of the cover 20. The protrusion 24 is extended from a top end 231 of the receiving portion 23 outwardly, and the protrusion 24 may be configured as a substantially conical structure. The receiving portion 23 is capable of receiving at least one portion of the passage structure 11 of the base 10 after the cover 20 is combined with the base 10, and the protrusion 24 is capable of being inserted into the opening edge 113 of the passage structure 11 when the cover 20 is moved relative to the base 10. In this embodiment, the cover 20 further comprises a second thread part 25 corresponding to the first thread part 13. The second thread part 25 is disposed in the receiving portion 23, and the corresponding retaining member 22 is arranged between the top end 231 and the second thread part 25.

The sealing member 30 is disposed between the passage structure 11 of the base 10 and the protrusion 24 of the cover 20. In this embodiment, the sealing member 30 is disposed in the groove 114 of the passage structure 11, but this disclosure is not limited thereto; for example, the sealing member 30 may also be disposed on the protrusion 24 of the cover 20. In this embodiment, the sealing member 30 is configured as an annular member and is made of plastic materials with elasticity.

To further describe the movement and operational states among the elements of this embodiment, thinner lines are used for representing the structures and parts of the valve 1 behind the cross-section in FIGS. 2 and 3. As illustrated in FIG. 2 and FIG. 3, in this embodiment, the corresponding retaining member 22 of the cover 20 is located between the retaining member 12 and the first thread part 13 of the base 10 once the cover 20 is combined with the base 10. Therefore, the retaining member 12 and the corresponding retaining member 22 may engage and block each other to prevent the cover 20 from being separated from the base 10 when the cover 20 moves relative to the base 10 so as to ensure the combination of the base 10 and the cover 20. The cover 20 combined with the base 10 is still capable of moving relative to the base 10, as illustrated in the first state A1 of FIG. 2 or in the second state A2 of FIG. 3.

When the cover 20 is moved toward the base 10 by a force to enable a contact between the first thread part 13 and the second thread part 25, the cover 20 is capable of being rotated around a central axis of the passage structure 11 of the base 10, so that the first thread part 13 engages gradually with the second thread part 25 until the cover 20 has moved relative to the base 10 to the first state A1 illustrated by FIG. 2. In the first state A1, the first thread part 13 of the base 10 engages the second thread part 25 of the cover 20 to form a fastened state, such that the protrusion 24 of the cover 20 is inserted into the opening edge 113 of the passage structure 11 and compresses the sealing member 30, thereby closing the flow path of fluid between the passage structure 11 and the receiving portion 23 of the cover 20 and forming a seal. Accordingly, in the first state A1, the valve 1 discontinues the flow of fluid therethrough and prevents the fluid from flowing to the cover 20 from the base 10 or flowing to the base 10 from the cover 20.

In addition, in the first state A1, the opening edge 113 of the passage structure 11 of the base 10 is abutted by the top end 231 of the receiving portion 23 of the cover 20, such that the cover 20 can no longer be fastened with respect to the base 10. With the configurational design, the valve 1 of the present disclosure may prompt a user that the cover 20 has been securely fastened, and the protrusion 24 is prevented from excessively extended into the passage structure 11 to break the sealing member 30. In other embodiments, the valve 1 according to the present disclosure may achieve a similar prompt effect by other means. In one non-limiting example, the cover 20 and/or the base 10 may be graduated or labelled to enable a user to determine and observe the degree of rotation or position of the cover 20 relative to the base 10.

In the first state A1, the cover 20 is capable of being rotated reversely around the central axis of the passage structure 11 of the base 10 by a force, and the cover 20 is moved away from the base 10 such that the protrusion 24 of the cover 20 is not in contact with the sealing member 30. In this situation, the protrusion 24 does not seal the passage structure 11 and is at least partially spaced apart from the passage structure 11 so as to define at least one fluid channel between the receiving portion 23 of the cover 20 and the passage structure 11 of the base 10. Because at least one hole 21 is in communication with the at least one fluid channel, the fluid may pass along the at least one fluid channel and through the at least one hole 21 in a flow direction illustrated as the dotted arrows shown in FIG. 3, known as the second state A2 according to the present disclosure. In the other words, once the at least one fluid channel is formed, regardless whether the first thread part 13 has been engaged with the second thread part 25, the cover 20 may be said to have been moved relative to the base 10 to the second state A2. In this embodiment, the configuration illustrated in FIG. 3 is used as an example to describe the second state A2, where the first thread part 13 is still engaged with the second thread part 25, but this disclosure is not limited thereto. For example, in the second state A2, the second thread part 25 of the cover 20 may be interposed between the first thread part 13 and the retaining member 12 of the base 10. Accordingly, in the second state A2, the valve 1 allows the flow of fluid therethrough so that the fluid may flow to the cover 20 from the base 10 or flow to the base 10 from the cover 20. Therefore, the user is capable of controlling the flow of fluid by rotating the cover 20 relative to the base 10.

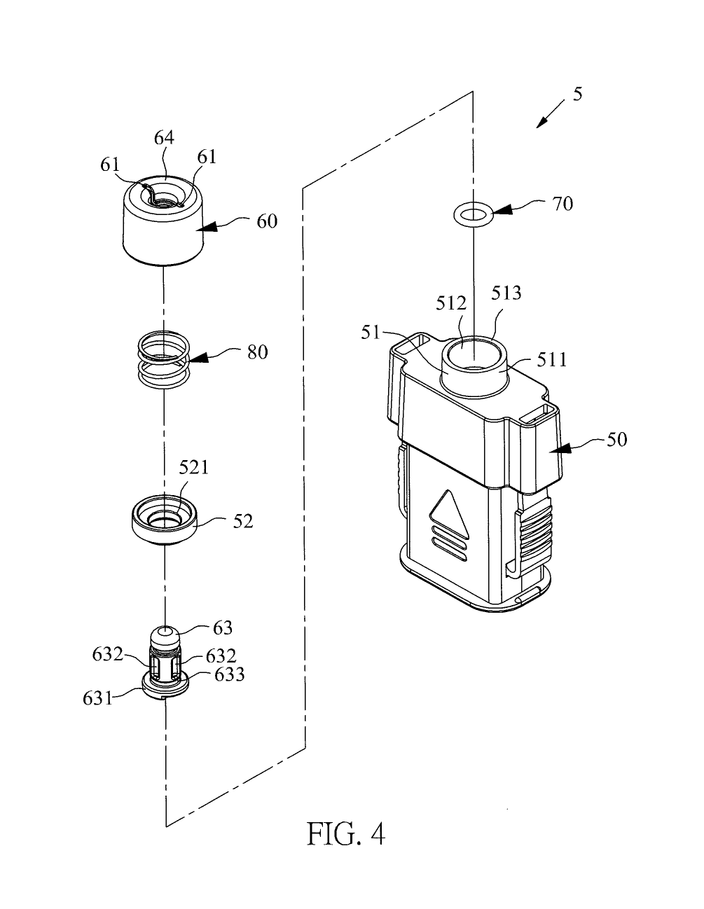

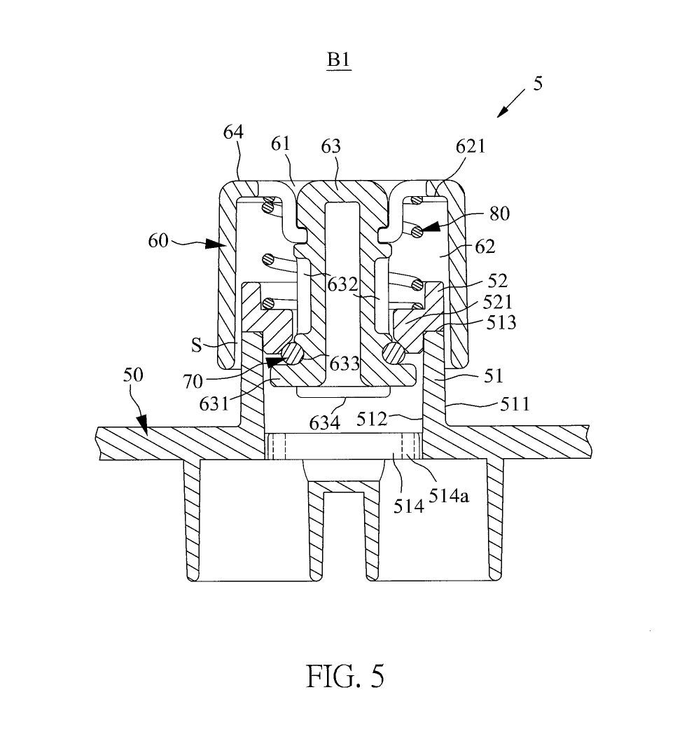

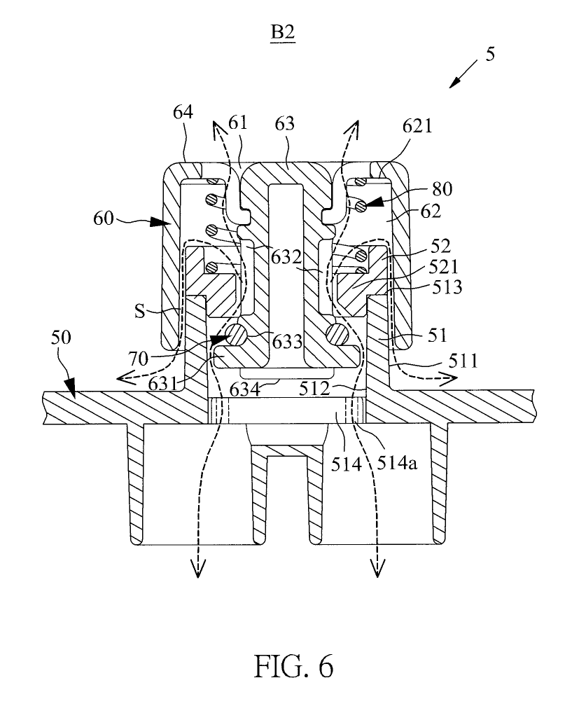

Refer to FIGS. 4 to 6, wherein FIG. 4 illustrates an exploded view of the second embodiment of a valve of this disclosure, FIG. 5 illustrates a partial cross-sectional view of the second embodiment of a valve of this disclosure in the first state, and FIG. 6 illustrates a partial cross-sectional view of the second embodiment of a valve of this disclosure in the second state. As illustrated in FIG. 4, the valve 5 comprises a base 50, a cover 60, a sealing member 70 and an elastic member 80, and the cover 60 is movably combined with the base 50.

The base 50 comprises a passage structure 51 and a retaining member 52. The passage structure 51 forms a pipe-like structure and comprises an outer side 511, an inner side 512 and an opening edge 513. The retaining member 52 is disposed at the opening edge 513 of the passage structure 51, and the retaining member 52 is configured as an annular structure with an inner flange 521. The inner flange 521 has a height and forms an incline structure on one side facing the opening edge 513. The passage structure 51 further comprises a blocking part 514 disposed on the inner side 512 of the passage structure 51 and apart from the opening edge 513. In this embodiment, a perforation 514a, as illustrated as the dotted portion of the blocking part 514 in FIG. 5, is formed in the blocking part 514 to define a passage for the flow of fluid, but the structural design of the blocking part 514 is not limited thereto.

The cover 60 comprises at least one hole 61, a receiving portion 62 and a protrusion 63. Each hole 61 is extended to the receiving portion 62 from an outer surface 64 of the cover 60. The protrusion 63 is extended from the outer surface 64 toward the receiving portion 62. The protrusion 63 in this embodiment is configured as a pillar-like structure, and a metal member for enhancing structural strength may be combined with a central portion of the protrusion 63. The protrusion 63 comprises a corresponding retaining member 631, a lateral recess 632 and a groove 633. The corresponding retaining member 631 has an annular protrusion structure, and the groove 633 is arranged between the lateral recess 632 and the corresponding retaining member 631. In this embodiment, the lateral recess 632 is a rectangular groove for forming a fluid channel, and the groove 633 is an annular groove for receiving the sealing member 70. In this embodiment, a length of the lateral recess 632 along a central axial direction of the protrusion 63 is greater than a height of the inner flange 521 of the retaining member 52. The receiving portion 62 is capable of receiving at least one portion of the passage structure 51 of the base 50 once the cover 60 has been combined with the base 50, and the protrusion 63 is movable in the passage structure 51 when the cover 60 is moved relative to the base 50.

The sealing member 70 is disposed between the passage structure 51 of the base 50 and the protrusion 63 of the cover 60. In this embodiment, the sealing member 70 is disposed in the groove 633 of the protrusion 63, but this disclosure is not limited thereto; for example, the sealing member 70 may also be disposed on the retaining member 52 of the base 50. The sealing member 70 is configured as an annular member in this embodiment and is made of plastic material with elasticity.

The elastic member 80 is disposed in the receiving portion 62 of the cover 60, and two ends of the elastic member 80 are abutted against the retaining member 52 of the base 50 and a top end 621 of the receiving portion 62 of the cover 60 respectively. The elastic member 80 is partially compressed when the base 50 is combined with the cover 60 to provide support to the cover 60 relative to the base 50 and elastic resilience.

To further describe the movement and operational states among the elements of this embodiment, thinner lines are used for representing the structures and parts of the valve 5 behind the cross-section in FIGS. 5 and 6. As illustrated in FIGS. 5 and 6, in this embodiment, the corresponding retaining member 631 of the protrusion 63 of the cover 60 is located between the retaining member 52 and the blocking part 514 of the passage structure 51 of the base 50 once the cover 60 has been combined with the base 50. Therefore, the retaining member 52 and the corresponding retaining member 631 may engage and block each other to prevent the cover 60 from being separated from the base 50 when the cover 60 is moved relative to the base 50 so as to ensure the combination of the base 50 and the cover 60. The cover 60, after being combined with the base 50, is still capable of moving relative to the base 50, as illustrated as the first state B1 in FIG. 5 or as the second state B2 in FIG. 6. Moreover, in this embodiment, a gap S is defined between the cover 60 and the outer side 511 of the passage structure 51 after the cover 60 is combined with the base 50.

When the cover 60 is not manipulated by a force, the compressed elastic member 80 provides support to the cover 60 toward a direction opposite to the base 50, and the corresponding retaining member 631 of the protrusion 63 and the sealing member 70 are driven to move by the cover 60. The sealing member 70 is compressed to abut against the incline structure of the retaining member 52 of the base 50 to fotm a seal so as to close the fluid channel between the passage structure 51 and the receiving portion 62 of the cover 60, as illustrated in FIG. 5. In this circumstance, the cover 60 is moved relative to the base 50 to the first state B1. Accordingly, the valve 5 discontinues the flow of fluid therethrough and prevents the fluid from flowing to the cover 60 from the base 50 or flowing to the base 50 from the cover 60.

The cover 60 in the first state B1 may be moved relative to and toward the base 50 by a force, such that the retaining member 521 of the base 50 is spaced apart from the sealing member 70. Because the length of the lateral recess 632 along the axial direction of the passage structure 51 is greater than the height of the inner flange 521 of the retaining member 52 after the cover 60 has been combined with the base 50, the inner flange 521 of the retaining member 52 of the base 50 is still kept in the region defined by the length of the lateral recess 632 of the protrusion 63 during the movement of the cover 60, and two ends of the lateral recess 632 are not closed or blocked by the inner flange 521 of the retaining member 52 to allow the flow of fluid therethrough. In this situation, the protrusion 63 is spaced apart from the passage structure 51, and the flow of fluid is made possible due to the arrangement of the lateral recess 632, thereby forming at least one fluid channel between the receiving portion 62 of the cover 60 and the passage structure 51 of the base 50. Since the at least one hole 61, the gap S formed between the cover 60 and the base 50, and the perforation 514a formed in the blocking part 514 are all in communication with the at least one fluid channel, the fluid is capable of passing through the at least one fluid channel from the perforation 514a and then flowing out of the at least one hole 61 and/or the gap S, and vice versa (wherein the fluid flows in a direction indicated by the dotted arrows in FIG. 6), presenting a configuration known as the second state B2 according to this disclosure. In other words, as long as the at least one fluid channel is formed, no matter how far the cover 60 is moved relative to the base 50, the cover 60 may be said to have been moved relative to the base 50 to the second state B2.

In addition, in the second state B2 as illustrated in FIG. 6, to prevent excessive movement of the cover 60 relative to the base 50 driven by an undue force, the movement distance of the cover 60 is limited by the blocking part 514 of the passage structure 51 abutting against the protrusion 63 of the cover 60. A bottom 634 of the protrusion 63 or the blocking part 514 of the passage structure 51 may be arranged with a groove for allowing the flow of fluid (not shown), such that the flow of fluid is still possible even if the blocking part 514 of the passage structure 51 is abutted against the protrusion 63 of the cover 60. Accordingly, the valve 5 of this disclosure is capable of prompting the user that the movement distance of the cover 60 has reached the limit to avoid the damage of the valve 5 caused by an undue force. In other embodiments, the valve 5 according to the present disclosure may achieve a similar prompt effect by other means. In one non-limiting example, the cover 60 and/or the base 50 may be graduated or labelled to enable a user to determine and observe the position of the cover 60 relative to the base 50.

In this embodiment, when the cover 60 is moved relative to the base 50 to the second state B2 in FIG. 6, the compression degree of the elastic member 80 may be increased by the force imposed thereon. Once the force is removed, the cover 60 may be moved toward the direction opposite to or away from the base 50 by the elastic recovery force from the elastic member 80 and return back to the first state B1 in FIG. 5. Accordingly, the cover 60 may be pressed to move relative to the base 50 by the user so as to control the valve 5 to allow or stop the flow of fluid.

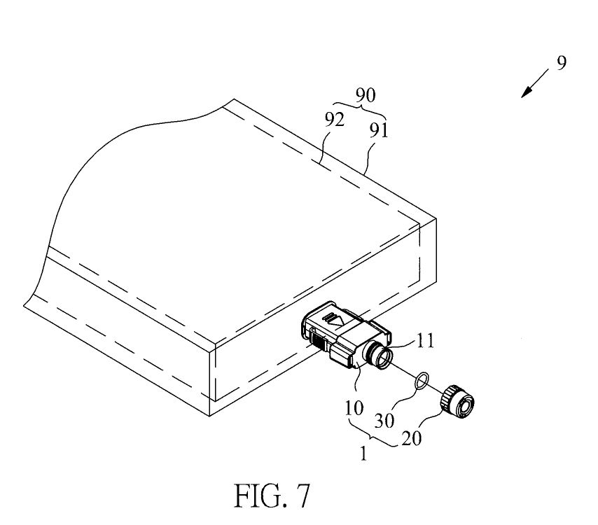

Refer to FIGS. 1 to 3 and 7, wherein FIG. 7 illustrates a perspective view of the first embodiment of a cushion system 9 of this disclosure. Herein the cushion system 9 is described in conjunction with the aforesaid first embodiment of the valve 1, but the aforesaid second embodiment of the valve 5 may also be used with the cushion system 9 without limitation.

As illustrated in FIG. 7, the cushion system 9 of this disclosure comprises a cushion member 90 and the aforesaid valve 1, wherein the valve 1 comprises the base 10, the cover 20 and the sealing member 30. The structural arrangement of the valve 1 may be referred from FIGS. 1 to 3 and the descriptions of the aforesaid first embodiment of the valve 1. The cushion member 90 comprises a covering member 91 and a foam material 92 (illustrated as the dotted portion in FIG. 7). In this embodiment, the cushion member 90 is a configured as a cell-type seat cushion, but this disclosure is not limited thereto. The covering member 91 is used for covering the foam material 92, and the base 10 is combined with the covering member 91, so that the fluid may only flow into or out of the covering member 91 through the passage structure 11 of the base 10. The covering member 91 in this embodiment is made of leather, cloth or other fabrics, and the foam material 92 may comprise a material with elasticity, such as a foam.

As illustrated above, the cushion system 9, by controlling the movement of the cover 20 of the valve 1 relative to the base 10, may be switched between the first state A1 for closing the valve 1 (see for example FIG. 2 and the associated descriptions of the first embodiment) or the second state A2 allowing the flow of fluid through the valve 1 (see for example FIG. 3 and the associated descriptions of the first embodiment). In the first state A1, the cover 20 closes the passage structure 11 of the base 10 by the sealing member 30 to prevent the flow of fluid through the cushion member 90. In the second state A2, at least one fluid channel is formed between the cover 20 and the passage structure 11, and at least one hole 21 is in communication with the at least one fluid channel, such that the fluid may pass through the at least one fluid channel and flow into or out of the cushion member 90 through the at least one hole 21 of the cover 20.

When the valve 1 is in the second state A2, if the cushion member 90 is compressed by an external pressure so as to deform the foam material 92, the fluid in the cushion member 90 is driven by the external pressure to move through the at least one fluid channel and flow out of the cushion member 90 from the at least one hole 21. When the external pressure is removed from the cushion member 90, the deformed foam material 92 with elasticity may recover gradually from a deformed state to an original shape so as to produce a suction force in the cushion member 90. Accordingly, the fluid is directed into the cushion member 90 from the at least one hole 21 of the valve 1 through the at least one fluid channel by the suction force to achieve automatic inflation.

The above detailed description is merely illustrative in nature and is not intended to limit the embodiments of the subject matter or the application and uses of such embodiments. Moreover, while at least one exemplary embodiment has been presented in the foregoing detailed description, it should be appreciated that a vast number of variations exist. It should also be appreciated that the exemplary one or more embodiments described herein are not intended to limit the scope, applicability, or configuration of the claimed subject matter in any way. Rather, the foregoing detailed description will provide those skilled in the art with a convenient guide for implementing the described one or more embodiments. Also, various changes can be made in the function and arrangement of elements without departing from the scope defined by the claims, which include known equivalents and foreseeable equivalents at the time of filing this patent application.

What is claimed is:

1. A valve for regulating the flow of a fluid therethrough, the valve comprising:
a base comprising a passage structure and a retaining member;
a cover comprising a corresponding retaining member and at least one hole, the cover being movably combined with the base and switchable between a first state and a second state relative to the base; and
a sealing member disposed between the passage structure of the base and the cover;
wherein the retaining member and the corresponding retaining member prevent the cover from being separated from the base when the cover moves relative to the base; in the first state, the cover closes the passage structure by the sealing member to prevent the flow of the fluid between the cover and the base; in the second state, at least one fluid channel is formed between the cover and the passage structure and the at least one hole is in communication with the at least one fluid channel.

2. The valve of claim 1, wherein the cover further comprises a receiving portion and a protrusion, the receiving portion is capable of receiving at least one portion of the passage structure, and the protrusion is capable of being inserted into the passage structure; and wherein the protrusion and the corresponding retaining member are disposed in the receiving portion, and the at least one hole passes through the receiving portion from an outer surface of the cover.

3. The valve of claim 2, wherein the base further comprises a first thread part, and the retaining member and the first thread part are disposed on an outer side of the passage structure; and wherein the cover comprises a second thread part corresponding to the first thread part, and the corresponding retaining member and the second thread part are disposed in the receiving portion.

4. The valve of claim 3, wherein the passage structure comprises a groove disposed on an inner side of the passage structure, and the sealing member is disposed in the groove; in the first state, the first thread part of the base engages the second thread part of the cover to form a fastened state, such that the protrusion is inserted into the passage structure to close the passage structure by the sealing member.

5. The valve of claim 4, wherein in the first state, the passage structure abuts a top end of the receiving portion to indicate the fastened state of the cover.

6. The valve of claim 3, wherein in the second state, the second thread part of the cover is arranged between the first thread part of the base and the retaining member, and the protrusion is at least partially spaced apart from the passage structure so as to form the at least one fluid channel between the receiving portion and the passage structure.

7. The valve of claim 2, wherein the at least one hole is in communication with the receiving portion from a lateral surface of the cover.

8. The valve of claim 2, wherein the sealing member is disposed on the protrusion of the cover

9. A cushion system, comprising:
a cushion member comprising a foam material and a covering member covering the foam material;
a base combined with the covering member, the base comprising a passage structure allowing the flow of a fluid therethrough and a retaining member;
a cover comprising a corresponding retaining member, the cover being movably combined with the base and switchable between a first state and a second state relative to the base; and
a sealing member disposed between the passage structure of the base and the cover;
wherein the retaining member and the corresponding retaining member prevent the cover from being separated from the base when the cover moves relative to the base; in the first state, the cover closes the passage structure by the sealing member to prevent the flow of the fluid through the cushion member; in the second state, at least one fluid channel is formed between the cover and the passage structure so as to allow the flow of the fluid to pass through the cushion member; and wherein the fluid is directed into the cushion member through the at least one fluid channel by the foam material recovering from a deformed state when an external pressure is removed from the cushion member.

10. The cushion system of claim 9, wherein the cover further comprises a receiving portion, a protrusion, and at least one hole, the receiving portion is capable of receiving at least a portion of the passage structure, and the protrusion is capable of extending into the passage structure; and wherein the at least one hole passes from an outer surface of the cover through the receiving portion so as to form fluid communication with the at least one fluid channel.

11. The cushion system of claim 10, wherein the base further comprises a first thread part, and the retaining member and the first thread part are disposed on the outer side of the passage structure; and wherein the cover comprises a second thread part corresponding to the first thread part, and the corresponding retaining member and the second thread part are disposed in the receiving portion.

12. The cushion system of claim 11, wherein the passage structure comprises a groove disposed on an inner side of the passage structure, and the sealing member is disposed in the groove; in the first state, the first thread part of the base engages the second thread part of the cover to form a fastened state, such that the protrusion is inserted into the passage structure to close the passage structure by the sealing member.

13. The cushion system of claim 12, wherein in the first state, the passage structure abuts a top end of the receiving portion to indicate the fastened state of the cover.

14. The cushion system of claim 11, wherein in the second state, the second thread part of the cover is arranged between the first thread part of the base and the retaining member, and the protrusion is at least partially spaced apart from the passage structure so as to form the at least one fluid channel between the receiving portion and the passage structure.

15. The cushion system of claim 10, further comprising an elastic member with two ends in contact with the base and the cover respectively, wherein a gap is formed between the cover and the passage structure; in the second state, the gap is in communication with the at least one fluid channel, and the cover is capable of moving relative to the base from the second state to the first state by an elastic restoring force of the elastic member.

16. The cushion system of claim 15, wherein the retaining member is disposed at an opening edge of the passage structure, and the corresponding retaining member is disposed on the protrusion.

17. The cushion system of claim 15, wherein the protrusion comprises a groove, and the sealing member is disposed in the groove; in the first state, the elastic member supports the cover, such that the protrusion inserted into the passage structure closes the passage structure by the sealing member.

18. The cushion system of claim 15, wherein the protrusion further comprises a lateral recess, and wherein in the second state, the protrusion is at least partially spaced apart from the passage structure so as to form the at least one fluid channel among the receiving portion, the lateral recess and the passage structure.

19. The cushion system of claim 18, wherein the retaining member comprises an inner flange, and a length of the lateral recess along an axial direction of the passage structure is greater than a height of the inner flange.

20. The cushion system of claim 15, wherein the protrusion further comprises a bottom, and the base further comprises a blocking part disposed in the passage structure; and wherein in the second state, the blocking part abuts the bottom to prevent the cover from moving relative to the base.
